(19) United States
(12) Patent Application Publication
(10) Pub. No.: US 2007/0256740 A1
(43) Pub. Date: Nov. 8, 2007

(54) Split flapper check valve including a torsion spring wear reduction mechanism

(75) Inventors: Maureen Sugai, Phoenix, AZ (US); David B. Tornquist, Chandler, AZ (US); Lisa Sedacca, Scottsdale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/418,799

(22) Filed: May 5, 2006

(51) Int. Cl. F16K 15/03

(52) U.S. Cl. 137/512.1

(57) ABSTRACT

A split flapper check valve includes a torsion spring wear reduction mechanism. In particular, the valve includes a pair of bushings on a shaft to which a pair of valve plates is rotationally mounted. A torsion spring is also mounted on the shaft and is configured to bias the valve plates toward a closed position. The wear reduction mechanism is implemented using a pair of bushings that are disposed between the shaft and the torsion spring.

### TECHNICAL FIELD

The present invention relates to split flapper check valves and, more particularly, to a split flapper check valve that has reduced wear of a torsion spring implemented therein.

### BACKGROUND

Split flapper check valves may be used in any one of numerous circumstances in which air flow may need to be regulated. In one example, the valve is implemented in an air distribution system. Typically, the air distribution system includes an inlet duct that receives air from an air source and two or more outlet ducts that exhaust the received air to a desired area within the aircraft, such as, for example, to an aircraft cabin or an underfloor section of the aircraft. The valve is disposed between the inlet and outlet ducts to prevent reverse flow in the air distribution system by moving between open and closed positions.

Generally, the valve includes a valve body having an opening formed therethrough, a shaft that extends across the opening, two valve plates rotationally mounted on the shaft via lugs, and a torsion spring also mounted on the shaft between the lugs. The ends of the torsion spring are coupled to the two valve plates. During operation, when the valve is in the closed position, the torsion spring maintains the valve plates seated against the valve body. When airflow impinges on an upstream side of the valve plates, one or both of the valve plates unseat from the valve body to allow air to flow through the valve body opening.

Although split flapper check valves, such as the one described above, generally operate safely and reliably, these valves can exhibit certain drawbacks. For example, in some cases, the torsion spring may have a length that is less than the distance between the lugs. As a result, the torsion spring position may shift during operation and may undesirably abrade against the shaft, lugs, or the valve plates. In addition, since the torsion spring reacts the closing torque against the hinge pin, wear of the spring against the hinge pin may occur when the flappers rotate to the open and closed positions. Consequently, the spring and/or the valve plates may prematurely wear and may need to be repeatedly replaced.

Accordingly, there is a need for an improved split flapper check valve configuration that includes a torsion spring that does not abrade against the shaft or valve plate. In addition, it is desirable for the valve to be relatively inexpensive to implement. Furthermore, other desirable features and characteristics of the present invention will become apparent from the subsequent detailed description and the appended claims, taken in conjunction with the accompanying drawings and the foregoing technical field and background.

### BRIEF SUMMARY

The present invention provides a split flapper check valve that includes a torsion spring wear reduction mechanism to at least inhibit the torsion spring from abrading against the shaft or valve plate.

In one embodiment, and by way of example only, a split flapper check valve includes a valve body, a shaft, a first valve plate, a second valve plate, a torsion spring, a first bushing, and a second bushing. The valve body includes one or more flow passages formed therethrough. The shaft is coupled to the valve body. The first valve plate is rotationally mounted on the shaft, and includes a first lug extending therefrom that has a shaft opening formed therethrough through which the shaft extends. The second valve plate is rotationally mounted on the shaft, and includes a first lug extending therefrom that has a shaft opening formed therethrough through which the shaft extends. The second valve plate first lug is spaced apart from the first valve plate first lug. The torsion spring is mounted on, and surrounds at least a portion of, the shaft between the first and second valve plate first lugs, and has at least a first end and a second end. The first bushing is mounted on the shaft and has an axial section and a radial section. The axial section is disposed between the torsion spring and the shaft, and the radial section extends radially outwardly from the axial section and is disposed between the torsion spring first end and the first valve plate first lug. The second bushing is mounted on the shaft and has an axial section and a radial section. The axial section is disposed between the torsion spring and the shaft, and the radial section extends radially outwardly from the axial section and is disposed between the torsion spring second end and the second valve plate first lug.

Other independent features and advantages of the preferred split flapper check valve torsion spring reduction mechanism will become apparent from the following detailed description, taken in conjunction with the accompanying drawings which illustrate, by way of example, the principles of the invention.

### BRIEF DESCRIPTION OF THE DRAWINGS

FIG. 1 is a perspective view of an exemplary split flapper check valve;

FIG. 2 is a cross section view of the split flapper check valve depicted in FIG. 1 taken along line 2-2;

FIG. 3 is a close up of a portion of the split flapper check valve shown in FIG. 2; and

FIG. 4 is a cross section view of another exemplary split flapper check valve.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

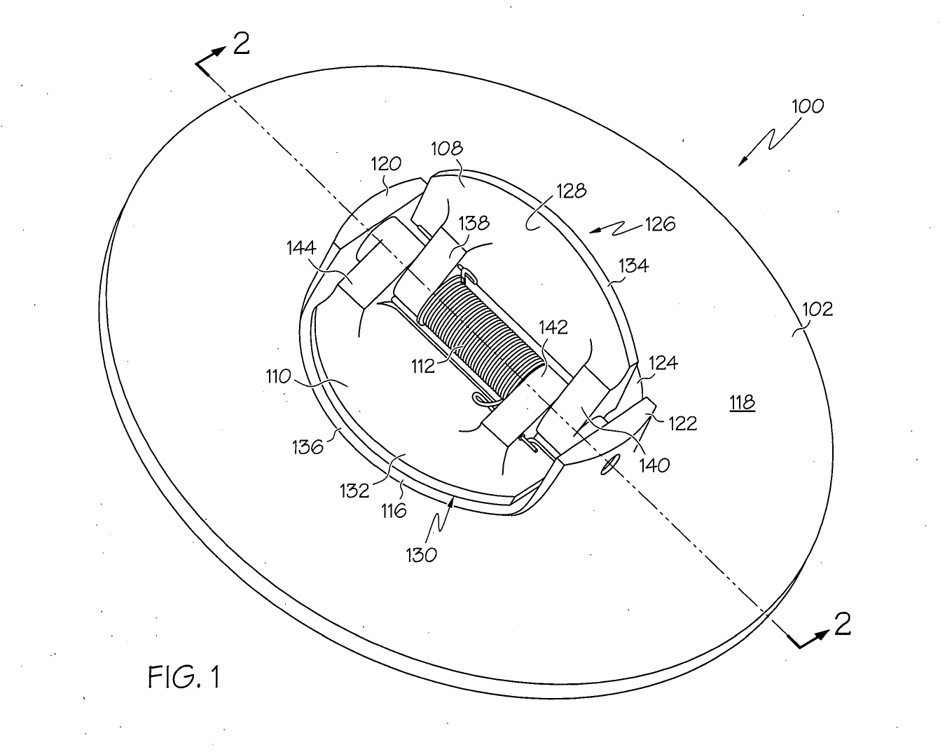

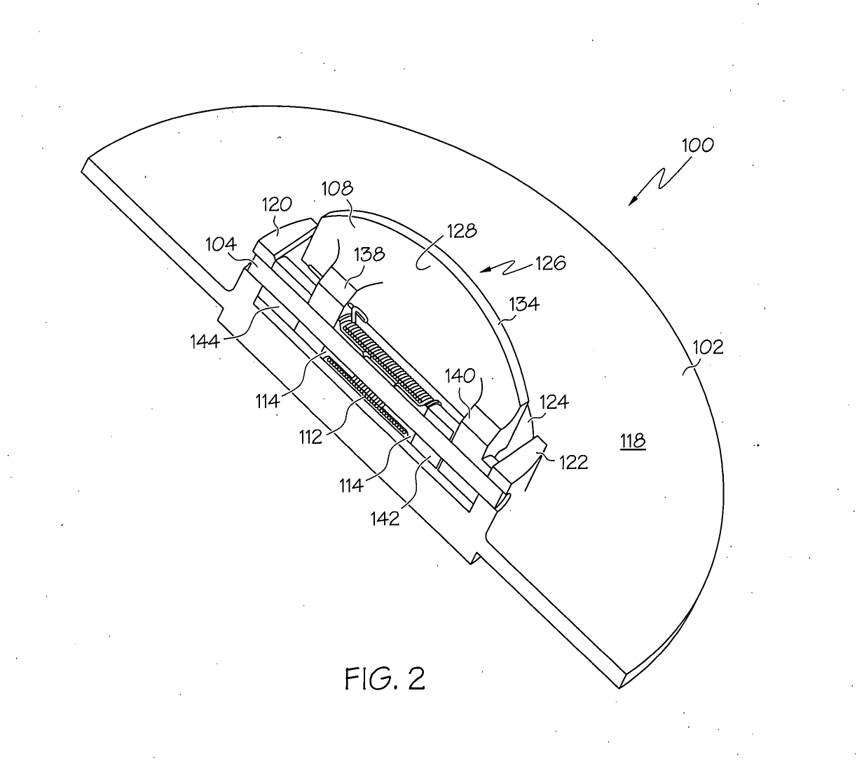

Turning now to FIGS. 1 and 2, a perspective view and a cross section view, respectively of an exemplary split flapper check valve 100 are illustrated. The check valve 100 includes a valve body 102, a shaft 104, one or more valve plates 108, 110, one or more torsion springs 112, and one or more bushings 114 (not visible in FIG. 1). The valve body 102 is configured to be coupled between two non-illustrated duct segments and includes a seat 116 with which the one or more valve plates 108, 110 contact when in a closed position. The valve body 102 includes an annular shroud 118 and a pair of mounting flanges 120, 122. The annular shroud 118 has one or more flow passages 124 formed therein through which air flows when the one or more valve plates 108, 110 are in an open position. The mounting flanges 120, 122 extend from the annular shroud 118 in a downstream direction, and each includes a shaft opening within which each end of the shaft 104 is disposed.

The valve plates 108, 110, as alluded to above, are configured to move between an open position to unseal the one or more flow passages 124, and a closed position to substantially seal the one or more flow passages 124. It is noted that in FIGS. 1 and 2, valve plate 108 is depicted in the open position, and in FIG. 1, valve plate 110 is depicted in the closed position. Each valve plate 108, 110 is rotationally mounted on the shaft 120, 122 and has an upstream face 126, 128 and a downstream face 130, 132. Each upstream face 126, 128 includes an outer periphery 134, 136 that contacts the valve seat 116 when in the closed position. Each downstream face 130, 132 includes a pair of lugs, specifically, a first pair of lugs 138, 140, and a second pair of lugs 142, 144. The lugs 138, 140, 142, 144 extend from their corresponding downstream faces 130, 132 in the downstream direction. Each lug 138, 140, 142, 144 has an opening formed therein through which the shaft 104 extends. Although one lug 138 of the first pair of lugs 138, 140 is shown disposed between the second pair of lugs 142, 144, it will be appreciated that in alternate embodiments, both lugs of the first pair of lugs 138, 140 may be disposed between the lugs of the second pair of lugs 142, 144, or vice versa.

During operation, the valve plates 108, 110 are preferably biased toward the closed position via a torsion spring 112. In the depicted embodiment, the torsion spring 112 surrounds at least a portion of the shaft 114, between the lugs 138, 140, 142, 144. In particular, the torsion spring 112 is coupled to one lug 138 of the first pair of lugs 138, 140, to one lug 142 of the second pair of lugs 142, 144, and contacts each of the valve plates 108, 110 to supply a torsion force that biases the valve plates 108, 110 toward the closed position. If, however, a differential pressure between the upstream faces 126, 128 and downstream faces 130, 132 of the valve plates 108, 110 exceeds a predetermined positive differential pressure value, one or both of the valve plates 108, 110 moves, against the bias of the torsion spring 112, to the open position. Before proceeding, it is noted that the torsion spring 112 may be coupled to the valve plates 108, 110, to thereby supply the torsion force thereto, in any one of numerous ways, not just by contacting each valve plate 108, 110, as in the depicted embodiment.

To maintain the torsion spring 112 in a substantially fixed position relative to the shaft 104, the bushings 114 are included. The bushings 114 are mounted on the shaft 104 and are preferably made of material that does not abrade against the shaft 104, the torsion spring 112, the lugs 138, 140, 142, 144 or any other components of the check valve 100 with which it contacts. The particular material selected depends on the materials from which the shaft 104, the torsion spring 112, the lugs 138, 140, 142, 144, and other components are constructed. In one exemplary embodiment, the shaft 104, the torsion spring 112, and the lugs 138, 140, 142, 144 are made from stainless steel; in such case, the bushings 114 may be constructed from cobalt alloys, or any other suitable material.

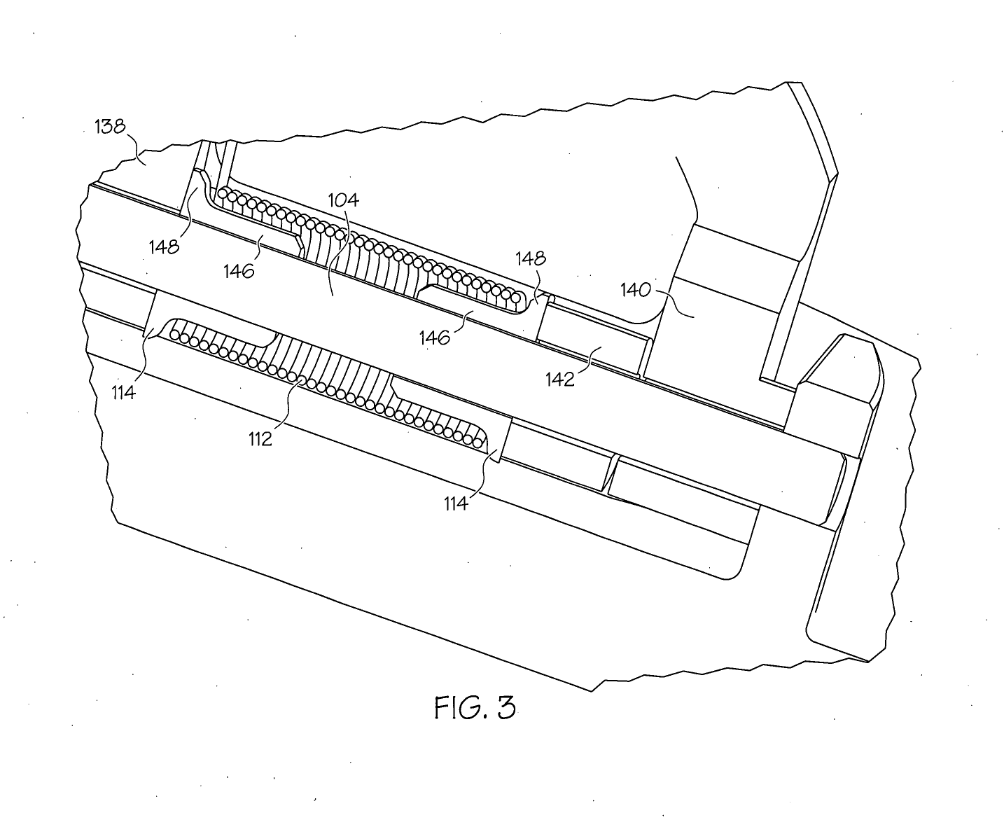

As shown in more detail in FIG. 3, each bushing 114 includes an axial section 146 and a radial section 148. The axial section 146 is configured to have a diameter that is smaller than an inner diameter of the torsion spring 112 so that it may be inserted therein; consequently, when the check valve 100 is fully assembled, the axial section 146 is disposed between the shaft 104 and the spring 112. The radial section 148 extends radially outwardly from a portion of the axial section 146 and has an outer peripheral diameter that is greater than an outer diameter of the torsion spring 112. The radial section 148, at least in the depicted embodiment, seats agains a portion of the of the lugs 138, 140, 142, 144.

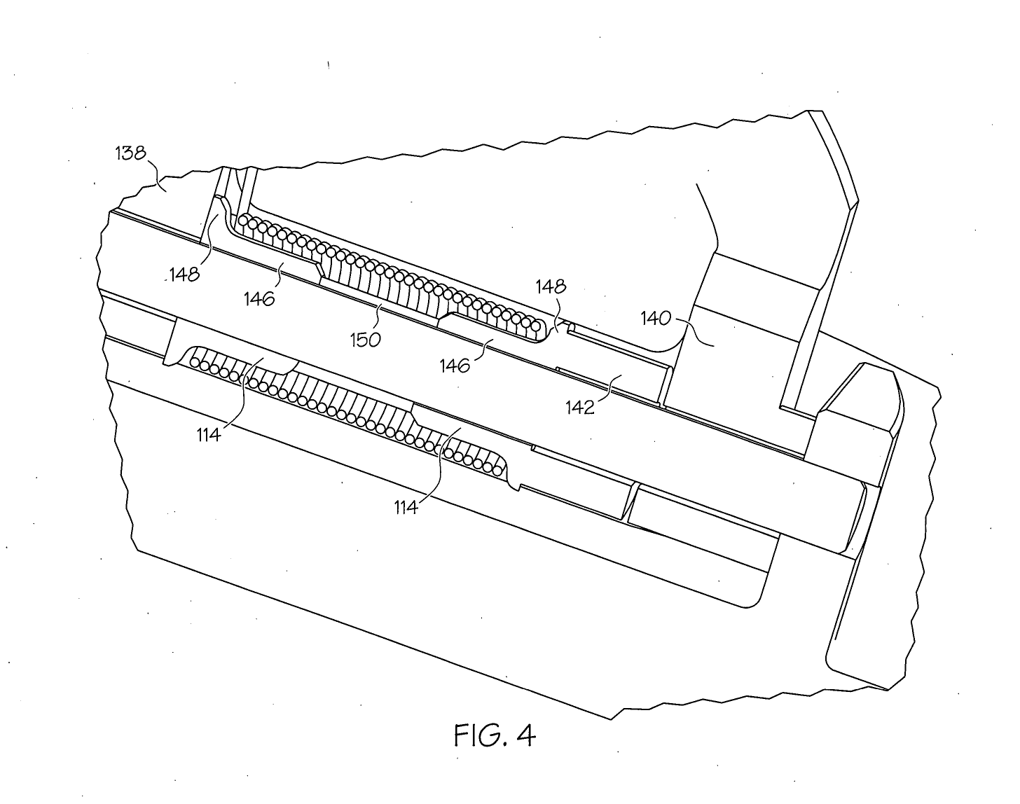

The bushings 114 are disposed one each at either end of the torsion spring 112 so that the radial section 148 of each of the bushings 114 is disposed between the torsion spring 112 and an adjacent lug 138, 140. It will be appreciated that in some cases, the torsion spring 112 may be short relative to the distance between the lugs lugs 138, 140. In such case, the bushing 114 radial sections 148 may be relatively thick. In other embodiments, the torsion spring 112 may be long relative to the distance between the lugs 138, 140, or the torsion spring 112 may have relatively small inner and outer diameters and may need additional support along its length. In such case, as shown in FIG. 4, a tubular sleeve 150 having an outer diameter that is smaller than the torsion spring 112 inner diameter may be positioned between the bushings 114. Although the bushings 114 are depicted in FIG. 3 as separate pieces from other components of the split flapper check valve 100, it will be appreciated that in some embodiments, such as the embodiment depicted in FIG. 4, one or more of the bushings 114 may be formed as an integral part of the lugs 138, 140.

A split flapper check valve 100 has now been provided that includes a torsion spring that does not abrade against the shaft or valve plate. In addition, the valve to be relatively inexpensive to implement.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A split flapper check valve comprising:
a valve body including one or more flow passages formed therethrough;
a shaft coupled to the valve body;
a first valve plate rotationally mounted on the shaft, the first valve plate including a first lug extending therefrom that has a shaft opening formed therethrough through which the shaft extends;
a second valve plate rotationally mounted on the shaft, the second valve plate including a first lug extending therefrom that has a shaft opening formed therethrough through which the shaft extends, the second valve plate first lug spaced apart from the first valve plate first lug;
a torsion spring mounted on, and surrounding at least a portion of, the shaft between the first and second valve plate first lugs, the torsion spring having at least a first end and a second end;
a first bushing mounted on the shaft and having an axial section and a radial section, the axial section disposed between the torsion spring and the shaft, the radial section extending radially outwardly from the axial section and disposed between the torsion spring first end and the first valve plate first lug; and.
a second bushing mounted on the shaft and having an axial section and a radial section, the axial section disposed between the torsion spring and the shaft and the radial section extending radially outwardly from the axial section and disposed between the torsion spring second end and the second valve plate first lug.

2. The system of claim 1, further comprising:
a sleeve mounted on, and surrounding at least a portion of, the shaft and disposed between the first and the second bushings.

3. The system of claim 2, wherein the sleeve has an outer diameter that is less than an inner diameter of the torsion spring.

4. The system of claim 1, wherein the torsion spring has an outer diameter, the first bushing radial section each has a diameter, and the torsion spring outer diameter is less than the first bushing radial section diameter.

5. The system of claim 1, wherein the first bushing is coupled to the first valve plate first lug.

6. The system of claim 5, wherein the second bushing is coupled to the second valve plate first lug.

7. The system of claim 1, wherein:
a first portion of the torsion spring is coupled to the first valve plate first lug and a second portion of the torsion spring is coupled to the second valve plate first lug.

8. The system of claim 1, wherein:
the first valve plate includes a second lug spaced apart from the first valve plate first lug;
the second valve plate first lug is disposed between the first valve plate first and second lugs;
the torsion spring is disposed between the first valve plate first lug and the second valve plate first lug.

9. The system of claim 8, wherein the second valve plate includes a second lug disposed outwardly of the first valve plate first and second lugs.

10. A split flapper check valve comprising:
a valve body including one or more flow passages formed therethrough;
a shaft coupled to the valve body;
a first valve plate rotationally mounted on the shaft, the plate including a first and a second lug extending therefrom, each lug having a shaft opening formed therethrough through which the shaft extends;
a second valve plate rotationally mounted on the shaft, the second valve plate including a first and a second lug extending therefrom, each lug having a shaft opening formed therethrough through which the shaft extends, the second valve plate first lug disposed between the first valve plate first and second lugs;
a torsion spring mounted on, and surrounding at least a portion of, the shaft between the first and second valve plate first lugs, the torsion spring having at least a first end and a second end;
a first bushing mounted on the shaft and having an axial section and a radial section, the axial section disposed between the torsion spring and the shaft and the radial section extending radially outwardly from the axial section and disposed between the torsion spring first end and the first valve plate first lug; and
a second bushing mounted on the shaft and having an axial section and a radial section, the axial section disposed between the torsion spring and the shaft and the radial section extending radially outwardly from the axial section and disposed between the torsion spring second end and the second valve plate first lug.

11. The system of claim 10, further comprising:
a sleeve mounted on, and surrounding at least a portion of, the shaft between the first and the second bushings.

12. The system of claim 11, wherein the sleeve has an outer diameter that is less than an inner diameter of the torsion spring.

13. The system of claim 10, wherein the torsion spring has an outer diameter, the first bushing radial section each has a diameter, and the torsion spring outer diameter is less than the first bushing radial section diameter.

14. The system of claim 10, wherein first bushing is coupled to the first valve plate first lug.

15. The system of claim 14, wherein the second bushing is coupled to the second valve plate first lug.

16. The system of claim 10, wherein:
a first portion of the torsion spring is coupled to the first valve plate first lug and a second portion of the torsion spring is coupled to the second valve plate first lug.

17. A split flapper check valve comprising:
a valve body including one or more flow passages formed therethrough;
a shaft coupled to the valve body;
a first valve plate rotationally mounted on the shaft, the first valve plate including a first and a second lug extending therefrom, each lug having a shaft opening formed therethrough through which the shaft extends;
a second valve plate rotationally mounted on the shaft, the second valve plate including a first and a second lug extending therefrom, each lug having a shaft opening formed therethrough through which the shaft extends, the second valve plate first lug disposed between the first valve plate first and second lugs and including an axially extending section and a radially extending section formed thereon;
a torsion spring including a first portion surrounding the shaft between the first and second valve plate first lugs, and a second portion mounted on the axially extending section of the second valve plate first lug, the torsion spring having a first end and a second end; and
a bushing section extending from the first valve plate first lug and mounted on the shaft, the bushing section having an axial section and a radial section, the axial section extending axially from the first valve plate first lug and disposed between the torsion spring and the shaft, and the radial section extending radially outwardly from the axial section and disposed between the torsion spring end and the first valve plate first lug.

18. The system of claim 17, further comprising:
a second bushing mounted on the shaft between the torsion spring second end and the second plate first lug; and
a sleeve mounted on and surrounding the shaft between the first and the second bushings.

19. The system of claim 18, wherein the sleeve has an outer diameter that is less than an inner diameter of the torsion spring.

20. The system of claim 17, wherein the torsion spring has an outer diameter, the first bushing radial section each has a diameter, and the torsion spring outer diameter is less than the first bushing radial section diameter.
